(19) United States
(12) Patent Application Publication
(10) Pub. No.: US 2005/0203756 A1
(43) Pub. Date: Sep. 15, 2005

(54) Computer network and method for manufacturing a computer network

(75) Inventors: Peter J. Pirich JR., Austin, TX (US); Alan M. Calcote, Austin, TX (US); Chad A. Hammerli, Austin, TX (US); John K. Hill, Leander, TX (US); Robert J. Johnson JR., Austin, TX (US); Anthony H. Kallus, Georgetown, TX (US); Daniel J. McAtee, Round Rock, TX (US); Joseph R. Petronis, Nashville, TN (US); Paul M. Seibert, Round Rock, TX (US); Kevin L. Strickland, Eatonton, NJ (US); Mark E. Trimble, Round Rock, TX (US); John A. Whipple, Austin, TX (US); Larry F. McElrath, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 10/796,390

(22) Filed: Mar. 9, 2004

(51) Int. Cl. G06F 17/60

(52) U.S. Cl. 705/1

(57) ABSTRACT

A computer network is manufactured according to a method in which the computer network is configured to function and be compatible with the resources of an existing computer network of the customer. The computer network is assembled and shipped to the customer as a single unit.

### TECHNICAL FIELD

The present disclosure relates generally to the field of computer or information systems, and, more particularly, to a method for manufacturing a set of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems, including computer systems, can be manufactured according to a build-to-stock or a build-to-order manufacturing process. A build-to-stock manufacturing model is characterized by the manufacture of quantities of identical products on the basis of forecasted demand. A build-to-order manufacturing process is characterized by the manufacture of the computer system or other product only after the time that an order is received for the product. A build-to-order manufacturing process facilitates the manufacture of customized products in response to customer orders, thereby reducing inventory requirements, as the products, once manufactured, may be shipped directly to the customer. A build-to-order manufacturing process is described in U.S. Pat. No. 6,236,901, which is incorporated herein by reference in its entirety.

A customer will often order a collection or set of computer system components that are to be assembled at the customer's location into a single computing system or computer network. These components may include, for example, computer servers, storage units, switches, routers, power supplies, and desktop and laptop computers. Often, each unit of the computing system or computer network is manufactured and shipped individually to the customer. The customer is then faced with the task of assembling, initializing, and configuring the computing system. In the specific case of a rack-based server system, the customer is faced with the task of removing the units from the boxes or pallets, physically connecting the units together, placing the units in the rack or racks, and installing the software of the computer network. This process of assembling, initializing, and configuring the computer network may be technically complex and time-consuming for the customer. In addition, the individual units of the computing system may not be shipped to or received by the customer at the same time. As a result, the customer may at some point have some, but not all, of the components of the computing system. In this case, the customer will have to wait until the final units of the computing system are delivered before the full installation of the computing system may be complete. In the interim, the previously shipped components of the computing system could become damaged, lost, or incorrectly installed. In sum, the process of shipping individual units to a customer so that the customer may assemble, initialize, and configure the units introduces complexities and opportunities for error on the part of the customer.

### SUMMARY

In accordance with the present disclosure, a computer network and a method for manufacturing a computer network is disclosed. Following the receipt of a customer order for a computer network, the components of the computer network are identified and a communication link is established between the computer network being manufactured and an existing computer network associated with the customer. Data concerning the service directory of the existing computer network is transmitted from the existing computer network to the computer network being manufactured. The components of the computer network are placed in an equipment rack and cabled together. The entire equipment rack, with the components of the computer network installed in the equipment rack, is prepared for shipment to the customer as a single unit. When the computer network is received by the customer, the service directory data of the computer network can be updated to reflect changes occurring since the initial transmission of the service directory. The computer network can be put in operation by supplying a power connection and a network connection to the customer's existing computer network.

The manufacturing method disclosed herein is advantageous in that it reduces the involvement of the customer in the process of configuring and installing a computer network. Because the computer network is pre-configured with the customer's existing computer network before shipment, the computer network can be operational with the computer existing network resources with little or no additional configuration necessary by the customer. The disclosed method also allows for the efficient deployment of network resources across a geographically distant computer network. Once the computer network is synchronized with the service directory of the customer's existing computer network, the computer network can be shipped to and installed in a distant location with little additional involvement of the customer. The computer network disclosed herein is also advantageous in that it is shipped as a single unit, thereby allowing the computer network to be fully cabled and tested before shipment. In addition, the computer network is configured so that the software images installed on the computer network are user specific. In addition to joining the computer network to the customer's existing domain and replicating the customer's existing service directory, customer-specific software may be installed and tested by the manufacturer. The solution provides a computer network that is fully integrated, customized, tested, and ready to be put in operation upon receipt by the customer.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a computer network;

FIG. 2 is a logical diagram of an integrated computer network and the customer domain and service directory of an existing computer network;

FIG. 3 is a flow diagram of method steps for manufacturing, configuring, and installing an integrated computer network at a customer site; and

FIG. 4 is a pictorial view of an equipment rack having components of a computer network placed therein.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The manufacturing process disclosed herein involves the integration and shipment to the customer of a fully assembled and configured computer network, which will be referred to herein as an integrated computer network. Following the manufacture of the individual units of the computer network, the units are initialized and software is installed on or more of the individual units, including the server or other processing unit. As part of the software installation and customization process, the integrated computer network is coupled through a virtual private network (VPN) to a computer network associated with the customer. The integrated computer network is linked to the domain controller of the domain of the customer's existing computer network. The service directory of the customer's existing computer network is downloaded to and installed on the integrated computer network. After the installation of software on the individual units, the units are assembled in a rack or other enclosure and connected to one another through cabling. The integrated network is tested at the factory and then shipped, as one integrated unit, to the customer. At the customer's site, the service directory of the integrated computer network is updated to reflect changes that have occurred since the time that the service directory was originally installed in the integrated computer network.

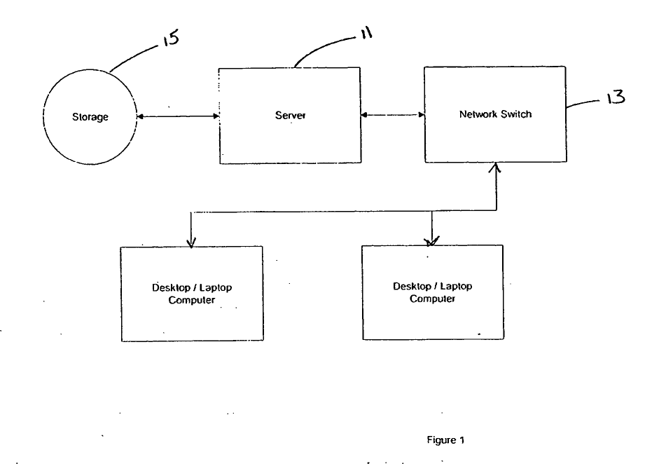

Shown in FIG. 1 is an example of a computer network, which is indicated generally at 19. The computer network includes a network switch 13, which is coupled to each of a server 11, a desktop, laptop, or other computer system 17, and a storage unit 15. In the computer network of FIG. 1, the server 11 acts as a processing unit for the computer network. Computer 17 serves as a point of access to the resources of the computer network, and storage 15 serves as a data repository that can be accessed by the server 11. Server 11 may transmit data through network switch 13 to any number of desktop or laptop computers. The computer network may also include a power distribution unit, an uninterruptible power supply, and a keyboard-video-mouse (KVM) switch for use in communicating with the server or servers of the computer network. It should be recognized that the computer network of FIG. 1 is an example of a computer network that may be assembled and shipped to a customer according to the methods disclosed herein. Variations to the network shown in FIG. 1 are possible, including variations in the number and types of components included in the network.

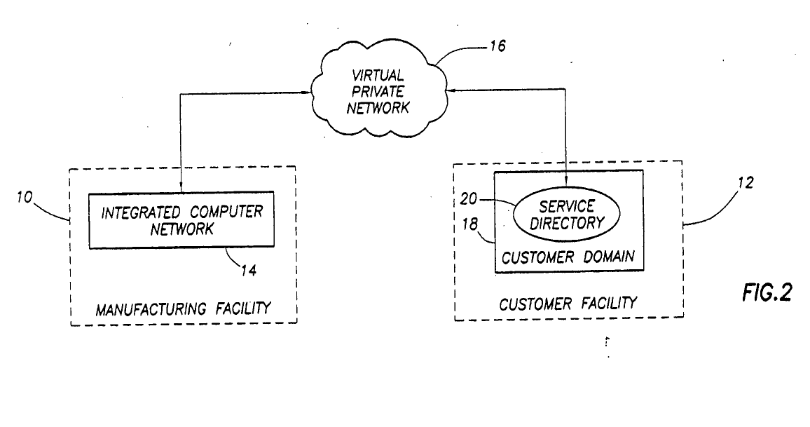

As part of the manufacturing process disclosed herein, the computer network being manufactured is pre-configured with the customer's existing computer network. Shown in FIG. 2 is a logical diagram of the relationship between the integrated computer network of the manufacturing facility and the customer domain and service directory of the existing computer network, which resides at the customer's facility. Shown in FIG. 2 is a manufacturing facility 10. Associated with the manufacturing facility 10 is an integrated computer network 14, which communicates through a virtual private network 16 with a customer domain 18 and a service directory 20 of an existing computer network at the customer facility 12. The virtual private network 16 is any type private communication network that is configured within a public network, such as the Internet. The virtual private network 16 provides for secure, site-to-site connections across geographic areas between the manufacturing facility 10, or some other site associated the manufacturer or seller, and a customer facility 12.

The customer domain 18 of FIG. 2 is a group of computer resources that are managed collectively within a computer network and share a common directory, which in this example is service directory 20. A service directory is a centralized database that reflects the computer resources of the computer network. In addition to cataloging information about the resources of a computer network, the service directory of a computer network can also play an active role in managing the distributed computer resources of a computer network. One example of a service directory that plays a role in the management of the resources of a computer network is Active Directory® for Windows® 2000, which is a product of Microsoft Corporation of Redmond, Wash. As a step in the manufacturing process of the present invention, the service directory of the existing computer network is installed in and built on the integrated computer network. Once the service directory of the customer's domain has been installed on the integrated computer network, the integrated computer network is configured to function within the customer's existing computer network.

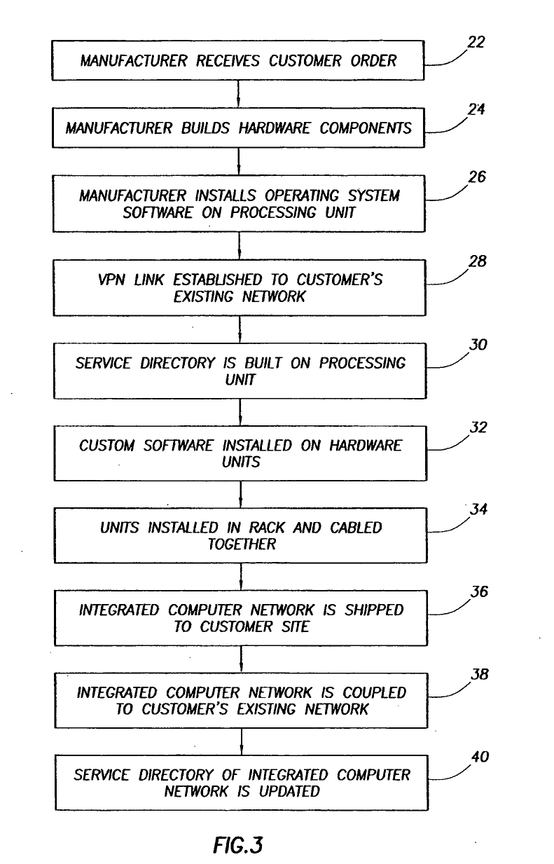

Shown in FIG. 3 is a flow diagram of a series of method steps for manufacturing, configuring, and installing an integrated computer network at a customer's place of business. At step 22, the manufacturer receives the customer order. The customer order may identify a number of specific units, including servers, storage arrays, switches, and power supply units, that are to be included as part of the integrated computer network. As an alternative, the customer may identify an integrated computer network that has a predefined configuration of components and a single stock keeping unit (sku). This predefined configuration may be uniquely associated with the customer or may be a configuration of components designed by the manufacturer. At step 24, following the receipt of the customer's order, the manufacturer builds the hardware components of the integrated computer network. It should be recognized that some or all of the individual units of the integrated computer unit may have been previously manufactured, in which case the manufacturer locates the previously manufactured units within its inventory or the inventory of one or more vendors.

At step 26 of FIG. 3, the manufacturer installs operating system software on the processing unit or units of the integrated computer network. The processing unit in many cases will be the server unit of the computer network. After operating system software is installed on the processing unit of the computer network, a VPN link is established at step 28 to the domain controller associated with the customer's existing computer network. At step 30, once the VPN link between the processing unit and the customer's existing computer network is established, the processing unit identifies for the existing computer network the resources of the integrated computer network that. The processing unit next downloads from the existing computer network the service directory of the computer network, which is then built on and accessible by the integrated computer network. The steps of communicating with the customer's existing computer network may be performed by accessing the customer's existing computer network at an administrator access level, thereby allowing a user associated with the manufacturer to access the service directory of the customer's existing computer network. At step 32, the remainder of the software of the integrated computer network, including any customer software ordered by the customer, is installed on the various units of the integrated computer network.

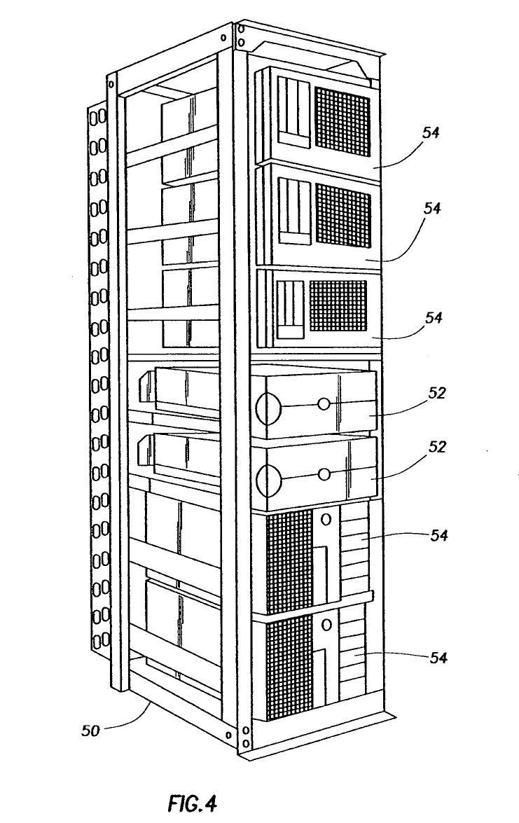

At step 34 of FIG. 3, the units are installed in an equipment rack and cables are connected between the units of the integrated computer network for the purpose of establishing power and communications links between the units. Shown in FIG. 4 is an example of the placement of the units of a computer network in an equipment rack. In the example of FIG. 4, the equipment rack 50 is a four post rack and includes within its compartments two server units 52 and five storage units 54. Not shown in the rack of FIG. 4 are a switch, power supplies, KVM switch, or a desktop or laptop computer. The equipment rack may also include a cable management arm for the handling of the power and network cables. The server units may each perform a dedicated function within the computer network. For example, one of the servers may function as a domain controller, while another of the servers functions as a print server or a file server. After the units of the integrated computer network have been placed in the equipment rack and physically coupled to one another with power and network cables, the entire equipment rack, with the integrated computer network included therein, is prepared for shipment. Once the units have been installed and cabled together on the equipment rack, the unit is tested by the manufacturer. The testing evaluates the performance of the network as a self-contained network. The test may consist of the computer network executing a series of scripts that resemble tasks that are common or critical to the customer. At step 36, the equipment rack and the integrated computer network included in the equipment rack are shipped as an entire unit to the customers. The units, which are now physically cabled to one another, are secured within the equipment rack. The rack itself is secured and placed in a container suitable for shipment of the entire rack. The equipment rack and its contents may be secured on a pallet, for example, and shipped by any suitable means that protects the content of the shipment and insures for timely delivery at the customer's place of business.

When the equipment rack and the integrated computer network arrive at the customer's location, the equipment rack is removed from the shipping container and the network is coupled at step 38 to customer's existing computer network. The step of coupling the integrated computer network to the customer's existing computer network involves supplying at least one power connection to the integrated computer network and connecting the integrated computer network to the customer's network through at least one communication cable. At step 40, the service directory of the integrated computer network is updated to reflect any changes to the service directory that occurred between the earlier download of the service directory (step 30) and the arrival of the integrated computer network at the customer's site.

The method disclosed herein reduces the cost to the customer of owning the computer network While at the factory, the computer network is assembled, configured, and testing. In addition, the service directory of the customer's computer network is installed on the integrated computer network, allowing the integrated computer network to be put into almost immediate use once delivered to the customer's facility. As such, when the computer network reaches the customer's site, the customer does not have to perform the time-consuming task of establishing a service directory on the computer network. Rather, the service directory is built on the configured computer network at the manufacturing site as part of the manufacturing process. The method disclosed herein allows the customer to quickly set up additional computing resources in its computer network. The customer may order a predefined configuration of computer components are pre-assembled into a computer network. The computer network includes the customer's custom software images, and, once delivered in a pre-assembled form at the customer's site, the computer resources are connected to the customer's existing computer network for operation. At this point, the integrated computer network is configured and operational within the customer's existing computer network.

The method described herein also allows a customer to quickly establish computer resources and to connect those resources in a network environment to other computer resources that are separated across large distances. By using the method described herein, a customer could deploy networked computer resources across a wide geographic area with little involvement by the customer in installing the computer networks. By installing the service directory of the existing computer network in an integrated computer network, the integrated computer network can be installed with little configuration by the customer in a physical location that is electronically coupled to but otherwise distant from the remainder of the computer network. In this way, the method disclosed herein may allow a customer to quickly establish computer network resources in various cities, with each computer network being pre-configured and quickly operation upon arrival at its destination.

The method disclosed herein reduces the customer's cost of ownership of the computer network. The computer network arrives in that the customer's location in a configured condition that allows the computer network to become operational by coupling the network to a power and a network communication link. The method disclosed herein is not limited in its application to the format and topology of any of the networks described herein. The system and method disclosed herein may be used with other networks, having varying formats and topologies. Although the present disclosure has been described in detail, it should be understood that various changes, substitutions, and alterations can be made hereto without departing from the spirit and the scope of the invention as defined by the appended claims.

1. A method for providing a computer network for a customer, wherein the computer network comprises a number of computing units, including a processing unit, comprising the steps of:
receiving an order for the computer network for the customer;
identifying the units of the computer network;
establishing a communication link between processing unit of the computer network and an existing computer network of the customer;
transferring to the computer network data concerning the service directory of the existing computer network of the customer; and
packaging the units for shipment to the customer.

2. The method for providing a computer network for a customer of claim 1, wherein the step of establishing a communication link comprises the step of establishing a virtual private network link between the processing unit of the computer network and the existing computer network of the customer.

3. The method for providing a computer network for a customer of claim 1, wherein the step of transferring to the computer network data concerning the service directory of the existing computer network of the customer, comprises the step of building a service directory on the computer network, wherein the service directory on the computer network is configured to function with the service directory of the existing computer network of the customer.

4. The method for providing a computer network for a customer of claim 1, wherein the step of packaging the network for shipment to the customer comprises the steps of:
placing the units of the computer network in a rack;
testing the computer network; and
shipping the rack, with the units included therein, to the customer.

5. The method for providing a computer network for a customer of claim 1,
wherein the step of transferring to the computer network data concerning the service directory of the existing computer network of the customer, comprises the step of building a service directory on the computer network, wherein the service directory on the computer network is configured to function with the service directory of the existing computer network of the customer; and
wherein the step of packaging the network for shipment to the customer comprises the steps of,
placing the units of the computer network in a rack;
testing the computer network; and
shipping the rack, with the units included therein, to the customer.

6. The method for providing a computer network for a customer of claim 1, further comprising the step, following the receipt of the computer network by the customer, updating the service directory with any changes since the step of building the service directory on the computer network.

7. A computer network, the computer network having a plurality of components, including a processing component, the computer network having been assembled for a customer and according to a method comprising the steps of,
identifying the components of the computer network;
establishing a communication link between the computer network and an existing computer network of the customer;
receiving at the computer network data concerning the service directory of the existing computer network of the customer
establishing a service directory in the computer network, the service directory being configured such that the computer network may function with the resources of the existing computer network of the customer;
testing the computer network; and
packaging the computer network for shipment to the customer.

8. The computer network of claim 7,
wherein the computer network is packaged for shipment to the customer such that the components are installed in an equipment rack; and
wherein the components and the equipment rack are secured for shipment such that the components and the equipment rack are shipped to the customer as a single unit.

9. A method for manufacturing a computer network, comprising the steps of:
receiving from a customer an order for a computer network;
identifying the components comprising the ordered computer network;
establishing a communications link between a processing unit of the ordered computer network and an existing computer network of the customer;
transmitting from the existing computer network of the customer to the processing unit of the ordered computer network data sufficient to synchronize the ordered computer network with the service directory of the existing computer network;
testing the computer network; and
packaging the ordered computer network for shipment to the customer.

10. The method for manufacturing a computer network of claim 9, further comprising the step of installing customer-specific software on the computer network.

11. The method for manufacturing a computer network of claim 9, wherein the step of establishing a communications link between the ordered computer network and the existing computer network comprises the step of establishing a virtual private network communication link between the ordered computer network and the existing computer network.

12. The method for manufacturing a computer network of claim 9, wherein the step of packaging the ordered computer for shipment to the customer, comprises the steps of:
placing the components of the computer network in an equipment rack;
installing cable connections between components; and
securing the components and the equipment rack for shipment such that the components and the equipment rack are shipped as a single unit.

13. The method for manufacturing a computer network of claim 12, further comprising the step of updating the data of the ordered computer network following the receipt of the ordered computer network by the customer to reflect changes to the service directory.

14. A method for manufacturing a computer network for a customer, the computer network having a plurality of units, including a processing unit, comprising the steps of:
establishing a communication link between the processing unit and an existing computer network of the customer;
transmitting through the communication link from the existing computer network of the customer to the processing unit of the computer network being manufactured data sufficient to establish a service directory at the processing unit of the computer network being manufactured, wherein the established service directory of the computer network being manufactured is configured with the service directory of the existing computer network of the customer; and
assembling the units of the computer network for shipment to the customer.

15. The method for manufacturing a computer network for a customer of claim 14, wherein the step of assembling the units of the computer network for shipment to the customer comprises the steps of:
placing the units of the computer network in an equipment rack; and
installing cable connections between units.

16. The method for manufacturing a computer network for a customer of claim 15, wherein the step of assembling the units of the computer network for shipment to the customer comprises the step of securing the units and the equipment rack for shipment such that the units and the equipment rack are shipped with the units installed within the equipment rack.

17. The method for manufacturing a computer network for a customer of claim 14, wherein the step of establishing a communication link between the processing unit and the existing computer network of the customer comprises establishing a virtual private network communication link between the processing unit and the existing computer network of the customer.

18. The method for manufacturing a computer network for a customer of claim 16, wherein the step of establishing a communication link between the processing unit and the existing computer network of the customer comprises the step of accessing the existing computer network with sufficient level of access authority to access the service directory of the existing computer network of the customer.

19. The method for manufacturing a computer network for a customer of claim 14, further comprising the step of installing customer-specific software on the units of the computer network.

20. The method for manufacturing a computer network for a customer of claim 14, wherein the manufacturing site of the computer network and the site of the existing computer network are geographically distant.
